(19) United States
(12) Patent Application Publication
(10) Pub. No.: US 2019/0228804 A1
(43) Pub. Date: Jul. 25, 2019

(54) DEVICE, METHOD, STORAGE MEDIUM, AND TERMINAL FOR CONTROLLING VIDEO STREAM DATA PLAYING

(71) Applicant: Shanghai Xiaoyi Technology Co., Ltd., Shanghai (CN)

(72) Inventors: Weilong GAO, Shanghai (CN); Liang ZONG, Shanghai (CN)

(73) Assignee: Shanghai Xiaoyi Technology Co., Ltd., Shanghai (CN)

(21) Appl. No.: 16/238,772

(22) Filed: Jan. 3, 2019

(30) Foreign Application Priority Data
Jan. 5, 2018 (CN) 201810010515.8

(51) Int. Cl. G11B 27/00; H04N 21/2343; H04N 21/2347

(52) U.S. Cl. CPC G11B 27/005; H04N 21/2347; H04N 21/234309

(57) ABSTRACT

A method and system for controlling video stream playing are disclosed. According to some disclosed embodiments, the method may include: determining video stream data, the video stream data having a first play frame rate; encoding the video stream data, according to one or more encoding parameters, to obtain encoded video stream data, wherein the one or more encoding parameters comprise an encoding frame rate that is less than the first play frame rate; setting a play timestamp for the encoded video stream data to obtain packaged video stream data, wherein the play timestamp instructs a second play frame rate that is greater than the encoding frame rate; and transmitting the packaged video stream data to a cloud server.

### CROSS-REFERENCE TO RELATED APPLICATION

The disclosure claims the benefits of priority to Chinese Application No. 201810010515.8, filed on Jan. 5, 2018, which is incorporated herein by reference in its entirety.

### FIELD OF TECHNOLOGY

The exemplary embodiments of the present disclosure relates to the field of data processing technology and, more particularly, to devices, methods, storage medium, and terminals for controlling a video stream data playing.

### BACKGROUND

With technological advancement, applications of image sensor technology have been increasingly growing. For example, surveillance video cameras have been commonly used in many sectors such as in security, industry, and commerce.

With currently available technology, a video camera is usually used to record the surrounding environment, and the user, when the need arises, may play back and view the video data recorded in the video camera.

However, since the video data recorded in the video camera is usually large in volume, viewing the recorded video data is time-consuming for the user. Therefore, there is a pressing demand for a video stream data playing control method that may increase the play-back speed at the user's end to allow the user to view the video data more efficiently.

### SUMMARY

The technical problem addressed by the exemplary embodiments of the present disclosure is to provide a video stream data playing control method, device, storage medium, and terminal, which may achieve a larger fast play multiple and better smoothness of play.

According to some exemplary embodiments, a video stream data playing control method is disclosed. The method may include determining video stream data, the video stream data having a first play frame rate. The method may also include encoding the video stream data according to one or more encoding parameters to obtain encoded video stream data, wherein the encoding parameters include an encoding frame rate that is less than the first play frame rate. The method may also include setting a play timestamp for the encoded video stream data to obtain packaged video stream data, wherein the play timestamp instructs a second play rate that is greater than the encoding frame rate. The method may further include transmitting the packaged video stream data to a cloud server.

In one embodiment, setting a play timestamp for the encoded video stream data may further include setting the play timestamp according to a fast play multiple and the encoding frame rate, wherein the fast play multiple is equal to a quotient of the second play frame rate instructed by the play timestamp and the encoding frame rate.

In one embodiment, the video stream data playing control method may further include playing, via a display device, the packaged video stream data according to a third play frame rate, wherein the third play frame rate is greater than the second play frame rate.

In one embodiment, the video stream data playing control method may further include playing, via a play device, the packaged video stream data.

In one embodiment, sending the packaged video stream data to a cloud server may further include encrypting the packaged video stream data to obtain encrypted video stream data, and sending the encrypted video stream data to the cloud server.

In one embodiment, the video stream data may have a first resolution, the encoding parameters may further include a second resolution that is lower than the first resolution, and the step of encoding the video stream data according to encoding parameters may further include encoding the video stream data according to the second resolution.

In one embodiment, the video stream data may have a first bit rate, the encoding parameters may further include a second bit rate that is smaller than the first bit rate, and the step of encoding the video stream data according to encoding parameters may further include encoding the video stream data according to the second bit rate.

According to some exemplary embodiments, a video stream data playing control device is provided. The device may include a data determining module adapted to determine video stream data. The video stream data may have a first play frame rate. The device may further include an encoding module adapted to encode the video stream data according to encoding parameters to obtain encoded video stream data, wherein the encoding parameters include an encoding frame rate that may be less than the first play frame rate. The device may further include a timestamp setting module adapted to set a play timestamp for the encoded video stream data to obtain packaged video stream data, wherein a second play frame rate instructed by the play timestamp is greater than the encoding frame rate. The device may further include a transmitting module adapted to transmit said packaged video stream data to a cloud server.

In one embodiment, the timestamp setting module may further include a timestamp setting submodule adapted to set the play timestamp according to a fast play multiple and the encoding frame rate, wherein the fast play multiple is equivalent to a quotient of the second play frame rate instructed by the play timestamp and the encoding frame rate.

In another embodiment, the video stream data playing control device may further include a first play module adapted to play the packaged video stream data using a play device according to a third play frame rate, wherein the third play frame rate is greater than the second play frame rate.

In yet another embodiment, the video stream data playing control device may further include a second play module adapted to play the packaged video stream data on the cloud server using a play device.

In other embodiments, the sending module may further include an encryption submodule adapted to encrypt the packaged video stream data to obtain encrypted video stream data. The sending module may further include a transmitting submodule adapted to transmit the encrypted video stream data to the cloud server.

In another embodiment, the video stream data may have a first resolution, the encoding parameters may further include a second resolution that is lower than the first resolution, and the encoding module may further include a first encoding submodule adapted to encode the video stream data according to the second resolution.

In another embodiment, the video stream data may have a first bit rate, the encoding parameters may further include a second bit rate that is less than the first bit rate, and the encoding module may further include a second encoding submodule adapted to encode the video stream data according to the second bit rate.

In order to address the aforementioned technical problem, an exemplary embodiment of the present disclosure provides a non-transitory computer-readable medium comprising instructions that, when executed by a processor, cause the processor to perform the steps of the aforementioned video stream data playing control method.

In order to address the aforementioned technical problem, another exemplary embodiment of the present disclosure provides a terminal comprising a storage device storing instructions that, when executed by a processor, cause the processor to perform the steps of the aforementioned video stream data playing control method.

In comparison with currently available technology, the technical solution provided by the exemplary embodiments of the present disclosure has the following benefits.

In the exemplary embodiments of the present disclosure, video stream data may be determined, and the video stream data may have a first play frame rate. The video stream data may be encoded according to encoding parameters to obtain encoded video stream data, wherein the encoding parameters may include an encoding frame rate that is less than the first play frame rate. A play timestamp may be set for the encoded video stream data to obtain packaged video stream data, wherein a second play frame rate instructed by the play timestamp may be greater than the encoding frame rate. In addition, the packaged video stream data may be transmitted to a cloud server. In the aforementioned solution, after the first play frame rate of the video stream data is determined, a smaller encoding frame rate may be used to encode the video stream data and, when the video stream data is being packaged, a higher play frame rate may be set. In comparison to the currently available technology wherein, after the first play frame rate of the video stream data is determined, the same frame rate is used directly for encoding and the same frame rate is used directly for playing, the technology provided by the exemplary embodiments of the present disclosure may achieve a greater fast play multiple. In comparison to the currently available technology wherein choppiness is caused by the use of frame skipping or frame dropping, the technology provided by exemplary embodiments of the present disclosure may achieve greater smoothness of play.

Further, the play timestamp may be set according to a fast play multiple and the encoding frame rate, and the fast play multiple may be equivalent to a quotient of the second play frame rate instructed by the play timestamp and the encoding frame rate. In exemplary embodiments of the present disclosure, a more detailed fast play multiple may be set.

Further, by using a third play frame rate that is greater than the second play frame rate to play the packaged video stream data, the packaged video stream data may be fast played furthermore. Since a smaller encoding frame rate is used to encode the video stream data, fast play is already achieved to a certain degree; the further use of a greater play frame rate may achieve a greater fast play multiple, which may achieve a higher fast play multiple, thereby meeting the user's needs to a fuller extent.

Further, after the first bit rate of the video stream data is determined, the video stream data may be encoded according to a smaller bit rate, which may reduce the volume of the packaged video stream data downloaded by the play device.

Further, after the first resolution of the video stream data is determined, the video stream data may be encoded according to a smaller resolution, which may reduce the size of the video and increase the clarity of the video, thus improving user experience.

It is to be understood that both the foregoing general description and the following detailed description are exemplary and explanatory only and are not restrictive of the disclosed embodiments, as claimed.

### BRIEF DESCRIPTION OF DRAWINGS

FIG. 1 is a flowchart of a video stream data playing control method, in accordance with an exemplary embodiment of the present disclosure;

FIG. 2 is a flowchart of Step S12 illustrated in FIG. 1, in accordance with an exemplary embodiment of the present disclosure;

FIG. 3 is a flowchart of Step S14 illustrated in FIG. 1, in accordance with an exemplary embodiments of the present disclosure;

FIG. 4 is a flowchart of a video stream data playing control method, in accordance with another exemplary embodiment of the present disclosure;

FIG. 5 illustrates a video stream data playing control device, in accordance with an exemplary embodiment of the present disclosure.

FIG. 6 is a schematic diagram of a controller for video stream data playing control, in accordance with an exemplary embodiment of the present disclosure.

### DETAILED DESCRIPTION OF INVENTION

A video camera can be used to record its surrounding environment, and a user, when the need arises, may play back and view the video data recorded in the video camera. However, since the video data recorded in the video camera is usually large in volume, the viewing is time-consuming for the user.

Consistent with the disclosed embodiments, after video stream data is recorded or obtained by a video terminal, a video stream with a normal encoding frame rate is pushed to a cloud server, so that when the user uses a play device (for example, a smart terminal or an application (app)) to play cloud video, fast play is achieved by increasing video play frame rate.

However, with the method above, a relatively fast play speed is hard to achieve because limiting factors, such as network download speed, limit the fast play multiple. Specifically, when the volume of video data is large and the fast play multiple is relatively high, a higher network download speed and a higher refresh rate of the play device are usually required. For example, when said video is being fast played at a bit rate of 1 Mbps and a fast play multiple of 32, a network download speed of at least 32 Mbps is required; if the network download speed is lower than that, it is likely that the play will be choppy or not smooth. In the case where said playing device is a smartphone, the upper limit of the screen's refresh rate is usually 60 fps, where fps stands for frame per second, and the conventional video play frame rate is 20 fps; therefore, it can only achieve a fast play speed at 3 times the original speed or frame dropping will occur.

Alternatively or additionally, after video stream data is recorded or obtained by a video terminal, a video stream with a normal encoding frame rate is pushed to a cloud server, so that when play cloud video is played using a play device, a fast play effect is achieved by skipping or dropping frames while playing the video.

However, when the video terminal is configuring a video stream with frame skipping or frame dropping, it needs to seek an intra frame and then add the seeking code to the video stream, resulting in increased volume of data sent.

Alternatively or additionally, after video stream data is recorded or obtained by a video terminal, a frame-skipped or frame-dropped video stream is pushed to a cloud server, so that fast play is achieved using a play device to play cloud video.

However, when frame skipping is used, playing can only take place after seeking an intra frame, and the group of pictures (GOP) between intra frames is a fixed value for a given set of video data. Therefore, relatively few choices are available for setting the fast play multiple for fast play.

Through research, it has been discovered that, with currently available technology, after a first play frame rate of the video stream data is determined, the same frame rate is used directly for encoding, so that when a play device is instructed to play using the same play frame rate, a play speed that is the same as or similar to that of the video stream data is achieved. It has also been discovered that, when the play device is instructed to play using a larger play frame rate, a play speed within the capacity of the play device and the capacity of the network is achieved, making it difficult to achieve high play speed due to limits imposed by the capacity of the play device and the capacity of the network.

According to the exemplary embodiments of the present disclosure, video stream data may be determined, and the video stream data may have a first play frame rate. The video stream data may be encoded according to encoding parameters to obtain encoded video stream data, wherein the encoding parameters may comprise an encoding frame rate that may be less than said first play frame rate. A play timestamp may be set for the encoded video stream data to obtain packaged video stream data, wherein a second play frame rate instructed by the play timestamp may be greater than the encoding frame rate. The packaged video stream data may be sent or transmitted to a cloud server. After the first play frame rate of the video stream data is determined, a smaller encoding frame rate may be used to encode the video stream data and, when the video stream data is being packaged, a higher play frame rate may be set. In comparison to the currently available technology wherein, after the first play frame rate of the video stream data is determined, the same frame rate is used directly for encoding and the same frame rate is used directly for playing, the technology provided by the exemplary embodiments of the present disclosure may achieve a greater fast play multiple. In comparison to the currently available technology wherein choppiness is caused by the use of frame skipping or frame dropping, the technology provided by the exemplary embodiments of the present disclosure may achieve greater smoothness of play.

In order to make the aforementioned purposes, characteristics, and benefits of the exemplary embodiments of the present disclosure more evident and easier to understand, detailed descriptions of specific exemplary embodiments of the present disclosure are provided below with reference to the drawings attached.

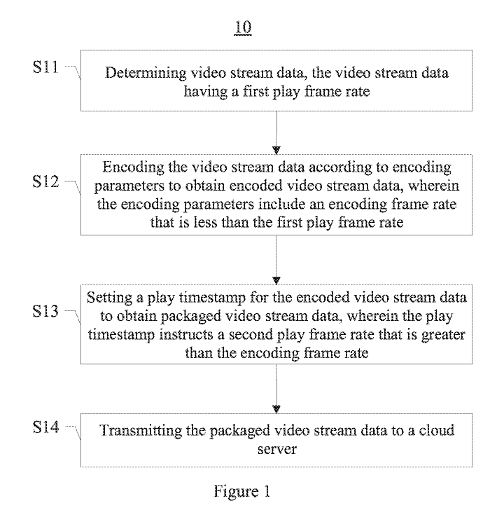

FIG. 1 illustrates a flowchart of a video stream data playing control method 10, in accordance with an exemplary embodiment of the present disclosure. For example, method 10 may be performed by a controller or a user terminal configured to control video stream data playing. Referring to FIG. 1, the video stream data playing control method 10 may include Steps S11 through S14.

Step S11 may include determining video stream data, the video stream data having a first play frame rate.

Step S12 may include encoding the video stream data according to encoding parameters to obtain encoded video stream data, wherein the encoding parameters may comprise an encoding frame rate that may be less than the first play frame rate.

Step S13 may include setting a play timestamp for the encoded video stream data to obtain packaged video stream data, wherein a second play frame rate instructed by the play timestamp may be greater than the encoding frame rate;

Step S14 may include transmitting the packaged video stream data to a cloud server.

In one exemplary embodiment of Step S11, a terminal may determine video stream data, the video stream data having a first play frame rate.

Consistent with the disclosed embodiments, the greater the first play frame rate is, the faster the play speed may be. In order to prevent a reduction in viewing experience caused by play speed distortion, in a non-limiting example the first play frame rate may be set to be 20 fps.

Specifically, the video stream data may be recorded by a terminal or obtained from another recording device.

More specifically, the terminal may be a terminal device having a video recording module, such as a server, workstation, smartphone, or tablet, wherein the video recording module, for example, may be a video camera set or a webcam. The terminal may also be a terminal device without a video recording function.

In one exemplary embodiment of Step S12, the terminal may encode the video stream data according to encoding parameters to obtain encoded video stream data. The encoding parameters may include an encoding frame rate that is less than said first play frame rate.

With currently available technology, usually an encoding frame rate that is the same as said first play frame rate is used for encoding (for example, setting the encoding frame rate to be 20 fps), which makes it difficult to achieve high play speed due to limits imposed by the capacity of the play device and the capacity of the network.

In one exemplary embodiment of the present disclosure, a smaller encoding frame rate may be used for the encoding of the video stream data (for example, setting the encoding frame rate to be 2 fps), so that on the play device side it may also be possible to fast play the video stream data even when a play frame rate smaller than the first play frame rate (for example, a play frame rate greater than 2 fps, such as 4 fps, 8 fps, and 16 fps) is used; this may be conducive to achieving a higher fast play multiple when a lower capacity play device (for example, a play device with a lower refresh rate upper limit) is used, thereby reducing the cost of use for the user.

In one exemplary embodiment, in addition to having the first play frame rate, the video stream data may further have other parameter data such as a first resolution and a first bit rate.

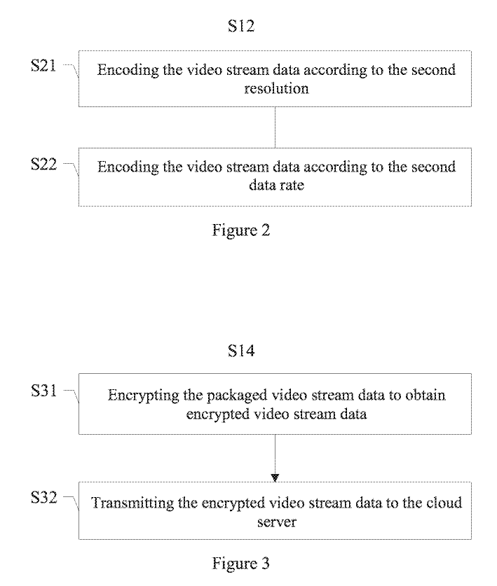

FIG. 2 illustrates a flowchart of an exemplary embodiment of Step S12 of FIG. 1. Referring to FIG. 2, the step of encoding the video stream data according to encoding parameters (i.e., step S12) may further include Step S21 and/or Step S22, each of which is described separately below.

In Step S21, the video stream data may have a first resolution, the encoding parameters may further include a second resolution that is lower than the first resolution, and the step of encoding the video stream data according to encoding parameters may further include encoding said video stream data according to the second resolution.

In an exemplary embodiment of the present disclosure, after the first resolution of the video stream data is determined, the video stream data may be encoded according to a smaller resolution, which may reduce the size of the video and increase the clarity of the video, thus improving user experience.

In Step S22, the video stream data may have a first bit rate, the encoding parameters may further include a second bit rate that is smaller than the first bit rate, and the step of encoding the video stream data according to encoding parameters may include encoding the video stream data according to the second bit rate.

In an exemplary embodiment of the present disclosure, after the first bit rate of the video stream data is determined, the video stream data may be encoded according to a lower bit rate, which may reduce the volume of said packaged video stream data downloaded by the play device.

Referring back to FIG. 1, in an exemplary embodiment of Step S13, the terminal may set a play timestamp for the encoded video stream data to obtain packaged video stream data, wherein the second play frame rate instructed by the play timestamp may be greater than the encoding frame rate.

With currently available technology, usually the timestamp is set using a second play frame rate that is the same as said encoding frame rate (for example, setting the timestamp to be 20 fps), so that the play device is instructed to play using said second play frame rate, preventing a reduction in viewing experience due to change of play speed.

In an exemplary embodiment of the present disclosure, in order to achieve fast play and allow the user to view video data more efficiently, the terminal may set the play timestamp according to a fast play multiple and the encoding frame rate. The fast play multiple may be equal to a quotient of the second play frame rate instructed by the play timestamp and the encoding frame rate.

Specifically, the fast play multiple may be set according to the user's need. For example, when video stream data covering a relatively long period of time (for example, a day, a week, etc.) needs to be viewed by the user over a short period of time, the fast play multiple may be set higher; otherwise, it may be set lower.

In an exemplary embodiment of the present disclosure, the fast play multiple may be equal to a quotient of the second play frame rate instructed by the play timestamp and the encoding frame rate; that is, the fast play multiple may be correlated with the second play frame rate instructed by the play timestamp and the encoding frame rate. Therefore, by setting a very small encoding frame rate for encoding the video stream data (for example, setting the encoding frame rate to be 2 fps) and then using the play timestamp to instruct the play frame rate of the play device to be a smaller play frame rate (for example, 4 fps, 8 fps, 16 fps, etc.), it may be possible to fast play the video stream data even when the play device uses a play frame rate smaller than the first play frame rate. This may be conducive to achieving a higher fast play multiple when a lower capacity play device (for example, a play device with a lower refresh rate upper limit) is used, thereby reducing the cost of use for the user.

In an exemplary embodiment, the play timestamp may be set according to the fast play multiple and the encoding frame rate, and the fast play multiple may be equal to a quotient of the second play frame rate instructed by the play timestamp and the encoding frame rate. In exemplary embodiments of the present invention, a more detailed fast play multiple may be set.

In one exemplary embodiment of Step S14, the terminal may send or transmit the packaged video stream data to a cloud server.

In the packaged video stream data, a smaller encoding frame rate may be used and a larger second play frame rate may be instructed by setting the play timestamp. Therefore, the play device may achieve fast play by directly using the second play frame rate instructed by the play timestamp for playing, with no need to make any change to the play device. This may be conducive to reducing the complexity of the play device.

FIG. 3 illustrates a flowchart of an exemplary embodiment of Step S14 of FIG. 1. Referring to FIG. 3, the step of transmitting the packaged video stream data to the cloud server (i.e., Step S14) may include Steps S31 through S32, each of which is described below.

In Step S31, the packaged video stream data may be encrypted to obtain encrypted video stream data.

In Step S32, the encrypted video stream data may be transmitted to the cloud server.

In an exemplary embodiment of the present disclosure, encryption of the packaged video stream data may strengthen the privacy protection of the user's data, thus improving user experience.

In an exemplary embodiment of the present disclosure, after the first play frame rate of the video stream data is determined, a smaller encoding frame rate may be used to encode the video stream data and, when the video stream data is being packaged, a higher play frame rate may be set. In comparison to the currently available technology wherein, after the first play frame rate of the video stream data is determined, the same frame rate is used directly for encoding and the same frame rate is used directly for playing, the technology provided by the exemplary embodiments of the present disclosure may achieve a greater fast play multiple. In comparison to the currently available technology wherein choppiness is caused by the use of frame skipping or frame dropping, the technology provided by the exemplary embodiments of the present disclosure may achieve greater smoothness of play.

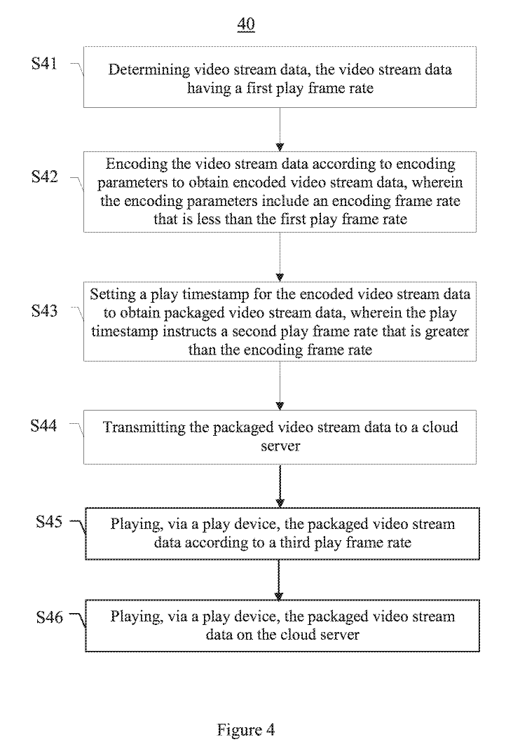

FIG. 4 illustrates a flowchart of a video stream data playing control method 40, in accordance with another exemplary embodiment of the present disclosure. For example, method 40 may be performed by a controller or terminal configured to control video stream data playing. Referring to FIG. 4, in addition to including Steps S11-S14 in method 10 (FIG. 1), method 40 may further include Step S41 and/or Step S42, each of which is described below.

In Step S41, the terminal may play, via a play device, the packaged video stream data according to a third play frame rate, wherein the third play frame rate may be greater than the second play frame rate.

In an exemplary embodiment of the present disclosure, by using the third play frame rate that is greater than the second play frame rate to play the packaged video stream data, the packaged video stream data may be fast-played furthermore. Since a smaller encoding frame rate is used to encode the video stream data, fast play may already be achieved to a certain degree. The further use of a greater play frame rate may achieve a greater fast play multiple, which may achieve a higher fast play multiple, thereby meeting the user's needs to a fuller extent.

It should be noted that in an exemplary embodiment, the packaged video stream data may also be played using a play device through another terminal device (for example, a terminal device geographically located on the user side); this may be conducive to custom-setting a play time and play parameters by the user, thereby improving user experience.

In Step S42, the terminal may play, via a display device, the packaged video stream data on the cloud server.

In an exemplary embodiment of the present disclosure, directly playing the packaged video stream data on the cloud server may enable the play device to play without finishing downloading the packaged video stream data, thereby reducing download time, increasing efficiency, and at the same time reducing dependency on the network's download capacity, thereby meeting the user's needs to a fuller extent.

It should be noted that in one exemplary embodiment, the packaged video stream data on the cloud server may also be played using a play device through another terminal device (for example, a terminal device geographically located on the user side); this may be conducive to custom-setting a play time and play parameters by the user, thereby improving user experience.

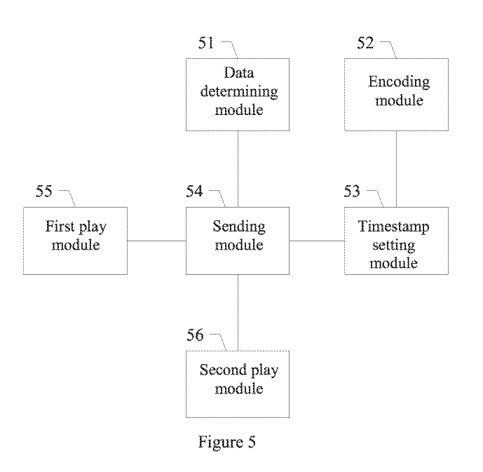

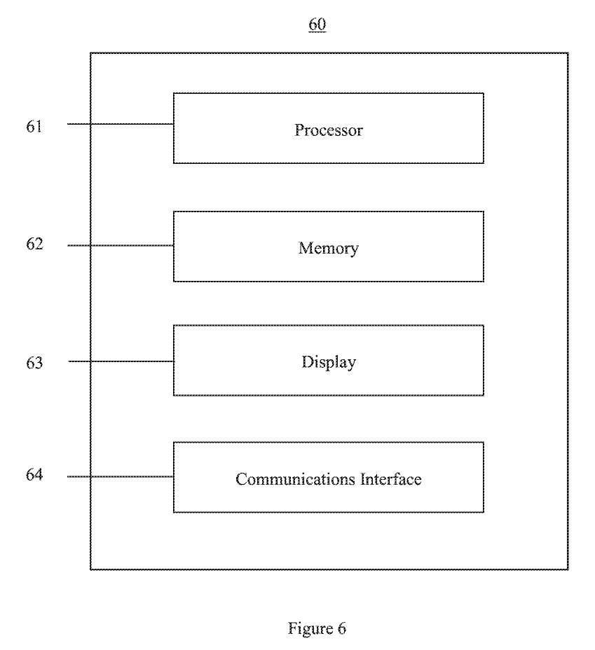

FIG. 5 illustrates a video stream data playing control device 500, in accordance with an exemplary embodiment of the present disclosure. Referring to FIG. 5, the video stream data playing control device 500 may include a data determining module 51, an encoding module 52, a timestamp setting module 53, a sending module 54, a first play module 55, and a second play module 56.

The data determining module 51 may be adapted to determine video stream data, and the video stream data may have a first play frame rate.

Then encoding module 52 may be adapted to encode the video stream data according to encoding parameters to obtain encoded video stream data. The encoding parameters may include an encoding frame rate that is less than said first play frame rate.

The timestamp setting module 53 may be adapted to set a play timestamp for the encoded video stream data to obtain packaged video stream data. The second play frame rate instructed by the play timestamp may be greater than the encoding frame rate;

The sending module 54 may be adapted to send the packaged video stream data to a cloud server.

The first play module 55 may be adapted to play the packaged video stream data using a play device according to a third play frame rate. The third play frame rate may be greater than the second play frame rate.

The second play module 56 may be adapted to play the packaged video stream data on the cloud server using a play device.

Further, the timestamp setting module 53 may include: a timestamp setting submodule (not shown in the figure), which may be adapted to set the play timestamp according to a fast play multiple and the encoding frame rate. The fast play multiple may be equal to a quotient of the second play frame rate instructed by the play timestamp and the encoding frame rate.

Further, the sending module 54 may include an encryption submodule (not shown in the figure) and a sending submodule (not shown in the figure).

The encryption submodule (not shown in the figure) may be adapted to encrypt the packaged video stream data to obtain encrypted video stream data.

The sending submodule (not shown in the figure) may be adapted to send the encrypted video stream data to the cloud server.

Further, the video stream data have a first resolution, the encoding parameters may further include a second resolution that is lower than the first resolution, and the encoding module 52 may include a first encoding submodule (not shown in the figure), which may be adapted to encode the video stream data according to the second resolution.

Further, the video stream data may have a first bit rate, the encoding parameters may further include a second bit rate that is less than said first bit rate, and the encoding module 52 may include a second encoding submodule (not shown in the figure), which adapted to encode the video stream data according to the second bit rate.

In accordance with another exemplary embodiment of the present disclosure, a non-transitory computer-readable medium may be provided. The non-transitory computer-readable medium may comprise instructions that, when executed by a processor, cause the processor to perform the steps of the video stream data playing control method illustrated in FIGS. 1 through 4. For example, the computer-readable medium may comprise a non-volatile storage device or a non-transitory storage device; it may also comprise a compact disc, a mechanical hard drive, a solid-state drive, etc.

According to another embodiment of the present disclosure, a controller or terminal 60 may be provided. The controller or terminal 60 may comprise a memory 62 storing instructions that, when executed by a processor 61, cause the processor 61 to perform the steps of the video stream data playing control method illustrated in FIGS. 1 through 4. The arrangement and number of components in controller or terminal 60 are provided for purposes of illustration. Additional arrangement, number of components, and other modifications may be made, consistent with the present disclosure. In some embodiments, the controller or terminal 60 may be a server or a workstation; it may also be a smartphone, a tablet, or another terminal device.

Controller or terminal 60 may also include one or more input/output (I/O) devices (not shown). By way of example, I/O devices may include physical keyboard, virtual touch-screen keyboard, mice, joysticks, styluses, etc. In certain exemplary embodiments, I/O devices may include a microphone (not shown) for providing input to controller or terminal 60 using, for example, voice recognition, speech-to-text, and/or voice command applications. In other exemplary embodiments, I/O devices may include a keypad and/or a keypad on a touch-screen for providing input to controller or terminal 60.

Controller or terminal 60 may also include one or more displays 63 for displaying data and information. Display 63 may be implemented using devices or technology, such as a cathode ray tube (CRT) display, a liquid crystal display (LDC), a plasma display, a light emitting diode (LED) display, a touch screen type display, a projection system, and/or any other type of display.

Controller or terminal 60 may further include one or more communications interface 64. Communications interface 64 may allow software and/or data to be transferred between controller or terminal 60 and other remote devices or the cloud server. Examples of communications interface 64 may include a modem, network interface (e.g., an Ethernet card or a wireless network card), a communications port, a PCMCIA slot and card, a cellular network card, etc. Communications interface 64 may transfer software and/or data in the form of signals, which may be electronic, electromagnetic, optical, or other signals capable of being transmitted and received by communications interface 64. Communications interface 64 may transmit or receive these signals using wire, cable, fiber optics, radio frequency (“RF”) link, Bluetooth link, and/or other communications channels.

Notwithstanding the above disclosure, the exemplary embodiments of the present disclosure is not limited thereby. Any person having ordinary skill in the art may make various alterations and changes that are not detached from the essence and scope of the embodiments of the present disclosure; therefore, the scope of protection for the embodiments of the present disclosure should be that as defined by the claims.

What is claimed is:

1. A method for controlling video stream data playing, comprising:
determining video stream data, the video stream data having a first play frame rate;
encoding the video stream data, according to one or more encoding parameters, to obtain encoded video stream data, wherein the one or more encoding parameters comprise an encoding frame rate that is less than the first play frame rate;
setting a play timestamp for the encoded video stream data to obtain packaged video stream data, wherein the play timestamp instructs a second play frame rate that is greater than the encoding frame rate; and
transmitting the packaged video stream data to a cloud server.

2. The method of claim 1, wherein setting the play timestamp for the encoded video stream data further comprises:
setting the play timestamp according to a fast play multiple and the encoding frame rate, wherein the fast play multiple is equal to a quotient of the second play frame rate and the encoding frame rate.

3. The method of claim 1, further comprising:
playing, via a play device, the packaged video stream data according to a third play frame rate, wherein the third play frame rate is greater than the second play frame rate.

4. The method of claim 1, further comprising:
playing the packaged video stream data via a play device.

5. The method of claim 1, wherein transmitting the packaged video stream data to the cloud server further comprises:
encrypting the packaged video stream data to obtain encrypted video stream data; and
transmitting the encrypted video stream data to the cloud server.

6. The method of claim 1, wherein:
the video stream data has a first resolution;
the one or more encoding parameters further comprise a second resolution that is lower than the first resolution; and
the step of encoding the video stream data according to the one or more encoding parameters further comprises:
encoding the video stream data according to the second resolution.

7. The method of claim 1, wherein:
the video stream data has a first bit rate;
the one or more encoding parameters further comprise a second bit rate that is less than the first bit rate; and
the step of encoding the video stream data according to the one or more encoding parameters further comprises:
encoding the video stream data according to the second bit rate.

8. A controller, comprising:
a memory storing instructions; and
a processor configured to execute the instructions to:
determine video stream data, the video stream data having a first play frame rate;
encode the video stream data according to one or more encoding parameters to obtain encoded video stream data, wherein the one or more encoding parameters comprise an encoding frame rate that is less than the first play frame rate;
set a play timestamp for the encoded video stream data to obtain packaged video stream data, wherein the play timestamp instructs a second play frame rate that is greater than the encoding frame rate; and
transmit the packaged video stream data to a cloud server.

9. The controller of claim 8, wherein the processor is further configured to execute the instructions to:
set the play timestamp according to a fast play multiple and the encoding frame rate, wherein the fast play multiple is equal to a quotient of the second play frame rate and the encoding frame rate.

10. The controller of claim 8, wherein the processor is further configured to execute the instructions to:
play, via a play device, the packaged video stream data according to a third play frame rate, wherein the third play frame rate is greater than the second play frame rate.

11. The controller of claim 8, wherein the processor is further configured to execute the instructions to:
play the packaged video stream data via a play device.

12. The controller of claim 8, wherein the processor is further configured to execute the instructions to:
encrypt the packaged video stream data to obtain encrypted video stream data; and
transmit the encrypted video stream data to the cloud server.

13. The controller of claim 8, wherein:
the video stream data has a first resolution;
the one or more encoding parameters further comprise a second resolution that is lower than the first resolution; and
the processor is further configured to execute the instructions to:
encode the video stream data according to the second resolution.

14. The controller of claim 8, wherein:
the video stream data has a first bit rate;
the one or more encoding parameters further comprise a second bit rate that is less than the first bit rate; and
the processor is further configured to execute the instructions to:
encode the video stream data according to the second bit rate.

15. A non-transitory computer-readable medium comprising instructions that, when executed by a processor, cause the processor to:
determine video stream data, the video stream data having a first play frame rate;
encode the video stream data, according to one or more encoding parameters, to obtain encoded video stream data, wherein the one or more encoding parameters comprise an encoding frame rate that is less than the first play frame rate;
set a play timestamp for the encoded video stream data to obtain packaged video stream data, wherein the play timestamp instructs a second play frame rate that is greater than the encoding frame rate; and
transmit the packaged video stream data to a cloud server.

16. The non-transitory computer-readable medium of claim 15, wherein the instructions further cause the processor to:
set the play timestamp according to a fast play multiple and the encoding frame rate, wherein the fast play multiple is equal to a quotient of the second play frame rate and the encoding frame rate.

17. The non-transitory computer-readable medium of claim 15, wherein the instructions further cause the processor to:
play, via a play device, the packaged video stream data according to a third play frame rate, wherein the third play frame rate is greater than the second play frame rate.

18. The non-transitory computer-readable medium of claim 15, wherein the instructions further cause the processor to:
encrypt the packaged video stream data to obtain encrypted video stream data; and
transmit the encrypted video stream data to the cloud server.

19. The non-transitory computer-readable medium of claim 15, wherein:
the video stream data has a first resolution;
the one or more encoding parameters further comprise a second resolution that is lower than the first resolution; and
the instructions further cause the processor to:
encode the video stream data according to the second resolution.

20. The non-transitory computer-readable medium of claim 15, wherein:
the video stream data has a first bit rate;
the one or more encoding parameters further comprise a second bit rate that is less than the first bit rate; and
the instructions further cause the processor to:
encode the video stream data according to the second bit rate.
